(19) United States
(12) Patent Application Publication
(10) Pub. No.: US 2012/0080621 A1
(43) Pub. Date: Apr. 5, 2012

(54) VALVE INTEGRATING A SENSOR

(75) Inventor: David Groslambert, Ornans (FR)

(73) Assignee: SCHRADER SAS, PONTARLIER (FR)

(21) Appl. No.: 13/377,255

(22) PCT Filed: Jun. 17, 2010
(86) PCT No.: PCT/FR10/51217

§ 371 Date: Dec. 9, 2011

(30) Foreign Application Priority Data
Jun. 26, 2009 (FR) 0954394

(51) Int. Cl. F16K 31/02; H01Q 1/44

(52) U.S. Cl. 251/129.04; 343/720

(57) ABSTRACT

A valve incorporates a sensor which can be remotely interrogated wirelessly. A body of the valve comprises a seat, a mobile assembly comprising a rod forming a plug with the seat, by way of a sealing component for closing off and releasing a fluid passage on command. The sensor is fixed to a base at the lower end of the rod.

### BACKGROUND

The invention relates to a valve incorporating a wireless sensor, i.e. which can be remotely interrogated wirelessly, such as a pressure and/or temperature sensor.

A valve making it possible to close off or to open a fluid passage on command such as a gas, air or liquid is known. It comprises for example an assembly mobile in translation in a body, comprised of a rod forming a plug by the intermediary of a sealing component pressing against a seat of the body. When the sealing component is thrust against the seat, the passage is closed off. When the rod is maneuvered, for example via a mechanical press, the passage is opened in order to allow the fluid to pass.

The contact of the sealing component mounted on the rod against the seat is provided for example by the pressure of the fluid itself, possibly assisted by a spring which acts on the rod. The maneuvering of the rod can be controlled manually, by an actuator or by the fluid itself when the pressure of the fluid tends to detach the base and its sealing element in relation to seat.

Sensors based on surface acoustic wave or guided elastic wave technologies making it possible to measure various physical magnitudes such as temperature or pressure are known. Document WO 93/13495 shows an example embodiment of a sensor of this type. Details on the operation of this type of sensor are not provided here, but it is simply indicated that the sensor is subjected to a pulse of electromagnetic waves emitted by an interrogation system, and that the sensor re-emits a response according to its state. The analysis of the response makes it possible to access the magnitude measured. An essential element in the operation is an antenna which makes it possible to capture the electromagnetic wave and to re-emit the response.

Document FR 2 843 562 shows a mounting system that is adapted to such a sensor on a vehicle wheel in order to measure the pressure inside a tire. The sensor is built into a capsule provided with a crown. A valve passes through the crown and an orifice of the rim of the wheel and thrusts the sensor against the rim.

The capsule of this sensor is off-centered in relation to its means of fastening, which makes it sensitive to the various accelerations to which it can be subjected and makes it fragile. In addition, the capsule must be maintained in place as long as the valve is not installed. In addition, the size of the capsule which is sought to be small imposes an antenna with reduced dimensions and limits the distance between the sensor and the interrogation system.

### SUMMARY OF THE INVENTION

The invention aims to provide a valve incorporating a sensor which is easy to mount, which is not sensitive to the mechanical stresses and of which the communication distance with the interrogation system is not too limited.

To this effect, the invention has for object a valve incorporating a sensor which can be remotely interrogated wirelessly, wherein a body comprises a seat, a mobile assembly comprising a rod forming a plug with said seat, by the intermediary of a sealing component in order to close off and release a fluid passage on command. The sensor is fixed to a base at the lower end of the rod.

As such, the sensitive portion of the sensor is housed directly inside the valve. In addition, the sensor being placed on the lower end of the rod provided with the sealing element forming a plug, it is as such placed next to the fluid retained by the valve, and is therefore subjected to the same conditions as the fluid itself. It is not necessary to provide a specific operation for mounting the sensor. The mounting operation of the valve is carried out at the same time as the mounting of the sensor. Furthermore, the sensor is mounted directly on a portion of the valve, which dispenses from having to use a capsule and from off-centering the sensor in relation to its means of fastening, according to prior art.

According to an advantageous arrangement, a first antenna element housed in the valve is connected to the sensor. The antenna as such is not limited in size by the size of the sensor, but can extend beyond it, according to the dimensions of the valve.

In a particular manner, the rod is electrically conductive and is connected electrically to the sensor, in such a way as to form the first antenna element. The rod, of elongated shape, as such directly forms a portion of the antenna, without the adding of a specific part for the antenna function.

In a complementary manner, a stopper is fixed in a removable manner to the body, the stopper comprising a conductive element in electrical contact with the rod in such a way as to form with the rod the first antenna element. Another already existing part is as such directly used to further increase the antenna element.

The stopper can be obtained for example via molding with the conductive element as an insert.

According to another arrangement, the stopper is made of metal and comprises the conductive element. It as such forms, due to the fact that it is conductive, an extension of the first antenna element beyond the rod. It is then necessary for the connection of the stopper on the body to be insulated electrically.

According to yet another arrangement, the stopper comprises a stopper body made of insulating material and containing the conductive element. It is then possible that the body of the valve be conductive, the stopper body creating an electrical insulation between the conductive wire and the body of the valve.

In a particular manner, the body is made of metal and is insulated from the rod by an insulating ring around the rod. The insulating ring allows the rod to fulfill its role of an antenna even if the rod is pressing in its housing, without interfering with the body.

In a complementary manner, the mobile element comprises a sealing component made of insulating material inserted between the base of the rod and the seat. In addition to the sealing function, the sealing component creates an electrical insulation between the rod and the body, also for the same reason as hereinabove.

According to an improvement, the conductive element of the stopper comprises an elastic element in order to provide the electrical contact with the rod. Causing a displacement of the rod when it is in contact with the stopper is as such avoided, a displacement which could cause sealing defects.

In a particular manner, the body is made of metal at least in part. This can be made necessary for questions of mechanical resistance.

According to another arrangement, a second antenna element is connected to the sensor and located opposite the first element in relation to the sensor, both antenna elements being insulated electrically. The second element advantageously supplements the first element and increases the effectiveness of the sensor.

According to a particular arrangement, the second antenna element comprises a spring pressing against the sensor and in electrical contact with said sensor. The spring as such has two functions, that of maintaining the base pressing against the seat, by the intermediary of the sealing component, and that of an electrical connection.

In a complementary manner, the valve comprises an electrically conductive tip, on an interior shoulder of which the spring is pressing, said tip being fixed to the body and supplementing the second antenna element. The tip is used for example for the fastening of the valve on another element. It is also used to increase the size of the second antenna element.

According to an additional characteristic, the body comprises a base made from electrically insulating material and separating the tip from the first antenna element. The electrical separation between both antenna elements on either side of the base of the body can as such be created easily.

### BRIEF DESCRIPTION OF THE DRAWINGS

The invention shall be better understood and other particularities and advantages shall appear when reading the following description, the description referring to the annexed drawings wherein:

FIG. 1 is a cross-section view of a valve according to a first embodiment of the invention;

FIG. 2 is a view similar to FIG. 1 of a second embodiment of the invention.

### DETAILED DESCRIPTION OF THE PREFERRED EMBODIMENT(S)

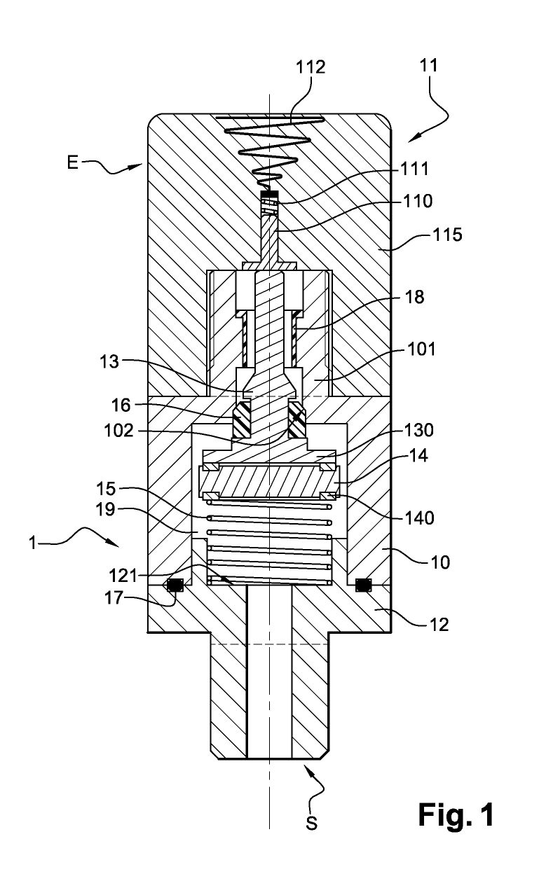

A valve 1 according to a first embodiment of the invention, shown in FIG. 1, is intended to close off a fluid reservoir, not shown, and to allow for the filling or the draining of the reservoir. The valve 1 comprises an inlet E to which an inflation tube can be connected and an outlet S intended to emerge inside the reservoir. By way of a non-restricted example, this reservoir can be a tire of a vehicle wheel or a membrane expansion vessel intended for heating installations.

The valve 1 comprises a metal body 10 of a generally tubular shape. On the inlet E side, the body 10 comprises a threaded portion 101 whereon a stopper 11 is screwed in a removable manner. On the outlet S side, a tip 12 is screwed into the body 10 on an internal threading. The tip 12 is also made of metal and a sealing O-ring 17 is inserted between the body 10 and the tip 12. The tip 12 is pierced axially and emerges in a passage chamber 19 delimited in the body 10.

A rod 13, forming a portion of the plug, with a revolution shape is mounted slidingly in the body 10 and extends from the inlet E to the passage chamber 19. The end of the rod 13 on the side of the passage chamber 19 is enlarged and forms a base 130. The body 10 comprises a seat 102 on the connection between the passage chamber 19 and the threaded portion 101. The valve 1 comprises an annular sealing component 16 carried by the rod 13 on the base 130 and which comes to press on the seat 102 in such a way as to close off the passage between the passage chamber 19 and the inlet E. In this position, the end of the rod 13 opposite the base 130 is flush with the end of the threaded portion 101. An insulating ring 18 made of synthetic material is inserted into the threaded portion 101 and surrounds the rod 13 by arranging a passage between the ring 18 and the rod 13.

A guided elastic wave sensor 14 is fixed to the base 130 at the lower end of the rod 13. The sensor 14 is as such housed in the passage chamber 19. The sensor 14 is in electrical contact with the rod 13 in order to connect the sensor 14 to a first antenna element. Moreover, a spring 15 of the helical type is housed in the passage chamber 19 and presses against on the one hand a shoulder 121 of the tip 12, and on the other hand on the sensor 14. The sensor 14 comprises a conductive circular ring 140 whereon the spring 15 is pressing in such a way as to be in electrical contact. The spring 15 is in electrical contact with the tip 12 and forms with it and the metal portion of the body 10 a second antenna element (see FIG. 1).

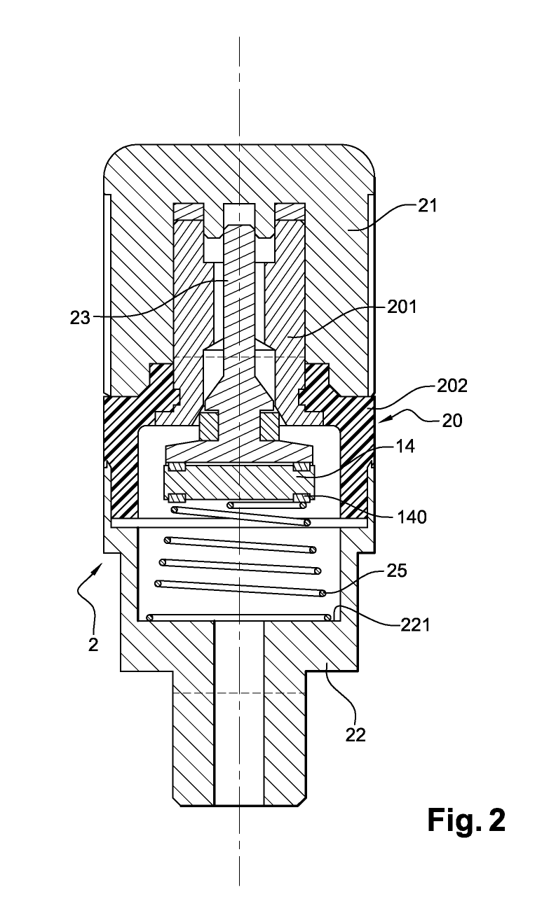

According to the alternative embodiment shown in FIG. 2, the valve comprises an electrically conductive tip 22, on a shoulder 221 of which the spring 25 is pressing against, the tip 22 being fixed to the body 20 in its insulating portion 202 and supplementing the second antenna element.

The stopper 11 comprises a plug body 115 made of synthetic material and a conductive wire 112 rolled and embedded in the plug body 115. The stopper 11 comprises a contact stud 110 mounted elastically in the axis of the rod 13 and making it possible to establish an electrical continuity between the rod 13 and the conductive wire 112. The rod 13, the contact stud 110 and the conductive wire 112 as such form the first antenna element.

In an improvement of this embodiment, the plug 21 is also made of an insulating material, and it is the unit comprised of the threaded portion 201 and of the rod 23 that creates the first antenna wire.

During the use of the valve 1, a supply tube, not shown, is connected to the inlet E in place of the stopper 11. A mechanical action is exerted or a fluid under pressure such as air or nitrogen is sent through the inlet E, which pushes back the rod 13 into the passage chamber 19 against the spring 15. The passage for the fluid is released between the seat 102 and the sealing component 16 carried by the rod 13. The fluid passes through the tip 12 and fills the reservoir. When the pressure of the fluid in the supply tube is suppressed or the mechanical action released, the rod 13 returns to press against the seat 102, by the intermediary of the sealing component, by the action of the spring and of the fluid contained in the reservoir and closes the passage of the fluid at this level. The passage chamber 19 is then subjected to the pressure in the reservoir.

The sensor 14, housed in the passage chamber 19 is subjected to the same conditions as those in the reservoir. It is therefore in a state to measure in particular the fluid pressure in the reservoir, but also any others physical magnitudes. A wave emitted by a reading device is captured by both antenna elements and transmitted to the sensor 14. As a response, the sensor 14 retransmits to the reading device a reflection wave which is re-emitted by both antenna elements.

In a second embodiment of the invention, shown in FIG. 2, the body 20 is made of two materials. The threaded portion 201 is a metal insert overmolded by a synthetic material forming a base 202 of the body 20. As such, the tip 22, screwed on the portion made of synthetic material of the body 20, is insulated electrically from the threaded portion 201. The plug 21 is made of metal and is in direct contact with the end of the rod 23 or by the intermediary of the threaded portion 201, on the inlet E side. As such, the rod 23, the threaded portion 201 and the plug 21 form the first antenna element, while the spring 25 and the tip 22 form the second antenna element. The operation remains similar to that of the first embodiment.

1-11. (canceled)

12. Valve incorporating a sensor which can be remotely interrogated wirelessly, wherein a body comprises a seat, a mobile assembly comprises a rod forming a plug with said seat, by the intermediary of a sealing component in order to close off and release a fluid passage on command, the sensor being fixed to a base at the lower end of the rod, a first antenna element being housed in the valve and connected to the sensor, a second antenna element connected to the sensor and located opposite the first element in relation to the sensor, and both antenna elements being insulated electrically.

13. Valve according to claim 12, wherein the body is insulated from the rod by an insulating ring around the rod.

14. Valve according to claim 12, wherein the mobile assembly comprises a sealing component made of insulating material inserted between the rod and the seat.

15. Valve according to claim 12, wherein the second antenna element comprises a spring pressing against the sensor and in electrical contact with said sensor.

16. Valve according to claim 15, further comprising an electrically conductive tip, on a shoulder on which the spring is pressing, and the tip being fixed on the body in an insulating portion and supplementing the second antenna element.

17. Valve according to claim 15, further comprising an electrically conductive tip on a shoulder on which the spring is pressing, and the tip being fixed on a metal portion of the body and comprises, with a metal portion, the second antenna element.

18. Valve according to claim 12, wherein the body comprises a base made of an electrically insulating material and separating a tip from the first antenna element.

19. Valve incorporating a sensor which can be remotely interrogated wirelessly, wherein a body comprises a seat, a mobile assembly comprising a rod forming a plug with said seat, by the intermediary of a sealing component in order to close off and release a fluid passage on command, the sensor being fixed to a base at the lower end of the rod, a first antenna element being housed in the valve and connected to the sensor, the rod being electrically conductive and connected electrically to the sensor, in such a way as to form the first antenna element, a plug made of insulating material fixed in a removable manner on the body, the plug comprising an conductive element in electrical contact with the rod in such a way as to form with the rod the first antenna element.

20. Valve according to claim 19, wherein the plug is metal and constitutes with the rod the first antenna element.

21. Valve according to claim 19, wherein the conductive element comprises an elastic element in order to provide the electrical contact with the rod.

22. Valve according to claim 19, wherein the body is made of metal at least in part and constitutes, by the intermediary of the rod, the first antenna element.
